(19) United States
(12) Patent Application Publication
(10) Pub. No.: US 2025/0177967 A1
(43) Pub. Date: Jun. 5, 2025

(54) MANUFACTURING METHOD OF SOLID COPPER-CARBON CATALYST

(71) Applicants: NATIONAL TSING HUA UNIVERSITY, HSINCHU (TW); Chang Chun Plastics Co., Ltd., TAIPEI (TW); Chang Chun Petrochemical Co., LTD., TAIPEI (TW); DAIREN CHEMICAL CORP., TAIPEI (TW)

(72) Inventors: De-Hao TSAI, Hsinchu (TW); Yung-Tin PAN, Hsinchu (TW); Yen-Te LEE, Hsinchu (TW); Dun-Zheng LIAO, Hsinchu (TW); Chien-Fu HUANG, Taipei (TW); Yi-Ta TSAI, Taipei (TW)

(21) Appl. No.: 18/739,421

(22) Filed: Jun. 11, 2024

(30) Foreign Application Priority Data
Nov. 30, 2023 (TW) 112146564

(51) Int. Cl. B01J 37/03; B01J 21/18; B01J 23/72; B01J 35/30; B01J 35/61; B01J 37/02; B01J 37/04; B01J 37/08

(52) U.S. Cl. CPC B01J 37/035; B01J 21/18; B01J 23/72; B01J 35/392; B01J 35/393; B01J 35/394; B01J 35/617; B01J 35/618; B01J 37/0236; B01J 37/04; B01J 37/088

(57) ABSTRACT

A manufacturing method of a solid copper-carbon catalyst includes the following steps: providing a copper precursor solution, performing a spraying step, performing a drying step, and performing a calcining step. The copper precursor solution includes a copper precursor, a carbon carrier and a first solvent. In the spraying step, the copper precursor solution is dispersed to form a plurality of copper precursor drops. In the drying step, the copper precursor drops are dried to form a plurality of copper precursor powders. In the calcining step, the copper precursor powders are calcined to form a plurality of solid copper-carbon catalysts.

### RELATED APPLICATIONS

This application claims priority to Taiwan Application Serial Number 112146564, filed Nov. 30, 2023, which is herein incorporated by reference.

### BACKGROUND

### Technical Field

The present disclosure relates to a manufacturing method of a solid catalyst. More particularly, the present disclosure relates to a manufacturing method of a solid copper-carbon catalyst for the synthesis of dimethyl carbonate.

### Description of Related Art

During the synthesis reaction of dimethyl carbonate (DMC), homogeneous copper chloride catalysts can be adopted to perform the catalytic reaction. The homogeneous copper chloride catalysts are easily dispersed into solvents and have the advantages of high-reactivity and high-selectivity. However, the uniform-mixing characteristics of the homogeneous copper chloride catalysts with reactants and products require distillation, extraction and other purification steps after the catalytic reactions to separate the products from the homogeneous copper chloride catalysts. In addition, the purification steps increase the production cost, and the large amount of waste water and energy consumption generated by the purification put burden on the environment. Particularly noteworthy, the homogeneous copper chloride catalysts can cause corrosion of metal reactors and pipelines. Therefore, surface treatment to prevent such corrosion is required to be applied to the inside surfaces of the metal reactors and pipelines, which greatly increases the equipment set-up costs.

Furthermore, noble metal palladium catalysts can also be used for the synthesis of dimethyl carbonate. Nevertheless, the price of the noble metal palladium catalyst is quite expensive, which is not conducive for carrying out mass production of dimethyl carbonate. Moreover, other auxiliary catalysts or solvents need to be added to ensure the smooth progress of the catalytic reaction, thereby resulting in increased process complexity. Additional purification equipment for the auxiliary catalysts or the solvents is also required, which further increases the production costs.

For all these reasons, it is necessary to develop a cost-effective catalyst for the synthesis of dimethyl carbonate, which is capable of minimizing the negative impact from the purification steps.

### SUMMARY

According to one aspect of the present disclosure, a manufacturing method of a solid copper-carbon catalyst comprises the following steps. A copper precursor solution including a copper precursor, a carbon carrier and a first solvent is provided. A spraying step is performed, wherein the copper precursor solution is dispersed to form a plurality of copper precursor drops. A drying step is performed, wherein the copper precursor drops are dried to form a plurality of copper precursor powders. A calcining step is performed, wherein the copper precursor powders are calcined to form a plurality of solid copper-carbon catalysts.

According to another aspect of the present disclosure, a manufacturing method of a solid copper-carbon catalyst comprises the following steps. A copper precursor solution including a copper precursor and a second solvent is provided. A carbon carrier solution including a carbon carrier and a third solvent is provided. A mixing-spraying step is performed, wherein the copper precursor solution and the carbon carrier solution are contacted and mixed to form a mixed solution, and the mixed solution is dispersed to form a plurality of mixture drops. A drying step is performed, wherein the mixture drops are dried to form a plurality of to-be-calcined powders. A calcining step is performed, wherein the to-be-calcined powders are calcined to form a plurality of solid copper-carbon catalysts.

According to a further embodiment of the present disclosure, a manufacturing method of a solid copper-carbon catalyst comprises the following steps. A copper precursor solution including a copper precursor, a carbon carrier and a fourth solvent is provided. An organic ligand solution including an organic ligand and a fifth solvent is provided. A mixing-spraying step is performed, wherein the copper precursor solution and the organic ligand solution are contacted and mixed to form a mixed solution, and the mixed solution is dispersed to form a plurality of mixture drops. A drying step is performed, wherein the mixture drops are dried to form a plurality of to-be-calcined powders. A calcining step is performed, wherein the to-be-calcined powders are calcined to form a plurality of solid copper-carbon catalysts.

### BRIEF DESCRIPTION OF THE DRAWINGS

The present disclosure can be more fully understood by reading the following detailed description of the embodiment, with reference made to the accompanying drawings as follows:

FIG. 1A is a flow chart of a manufacturing method of a solid copper-carbon catalyst according to one embodiment of the present disclosure.

FIG. 1B is a process diagram of the manufacturing method of the solid copper-carbon catalyst according to FIG. 1A.

FIG. 2A is a flow chart of a manufacturing method of a solid copper-carbon catalyst according to another embodiment of the present disclosure.

FIG. 2B is a process diagram of the manufacturing method of the solid copper-carbon catalyst according to FIG. 2A.

FIG. 3A is a flow chart of a manufacturing method of a solid copper-carbon catalyst according to a further embodiment of the present disclosure.

FIG. 3B is a process diagram of the manufacturing method of the solid copper-carbon catalyst according to FIG. 3A.

FIG. 4 is an X-ray diffraction image of the 1st example, the 2nd example, the 3rd example, the 4th example, the 5th example, the 6th example, the 7th example, the 8th example and the 9th example and an activated carbon powder.

FIG. 5 is an X-ray diffraction image of copper precursor powders of the 8th example and copper precursor powders of the 9th example, the activated carbon powder, and a standard HKUST-1.

FIG. 6A is a diagram showing the conversion rate results of the 1st example at different catalytic temperatures.

FIG. 6B is a diagram showing the selectivity results of the 1st example at different catalytic temperatures.

FIG. 7 is a diagram showing the conversion rate and selectivity changes of the 1st example under different reaction times.

FIG. 8A is a diagram showing the conversion rate results of the 1st comparative example, the 1st example, the 3rd example, the 4th example, the 6th example, the 8th example and the 9th example at a catalytic temperature of 120° C.

FIG. 8B is a diagram showing the selectivity results of the 1st comparative example, the 1st example, the 3rd example, the 4th example, the 6th example, the 8th example and the 9th example at the catalytic temperature of 120° C.

FIG. 9A is a diagram showing the conversion rate results of the 1st example, the 2nd example, the 4th example, the 5th example, the 6th example and the 7th example at the catalytic temperature of 120° C.

FIG. 9B is a diagram showing the selectivity results of the 1st example, the 2nd example, the 4th example, the 5th example, the 6th example and the 7th example at the catalytic temperature of 120° C.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof. In addition, some conventional structures and elements are illustrated in the drawings in a simple and schematic way, and repeated element can be presented by the same number or a similar number.

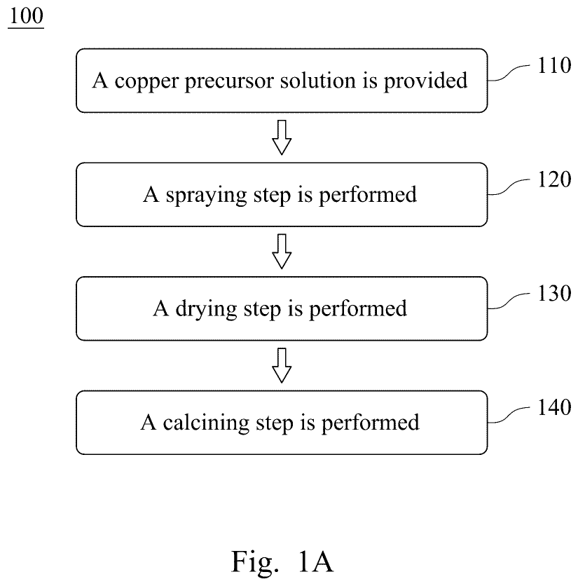

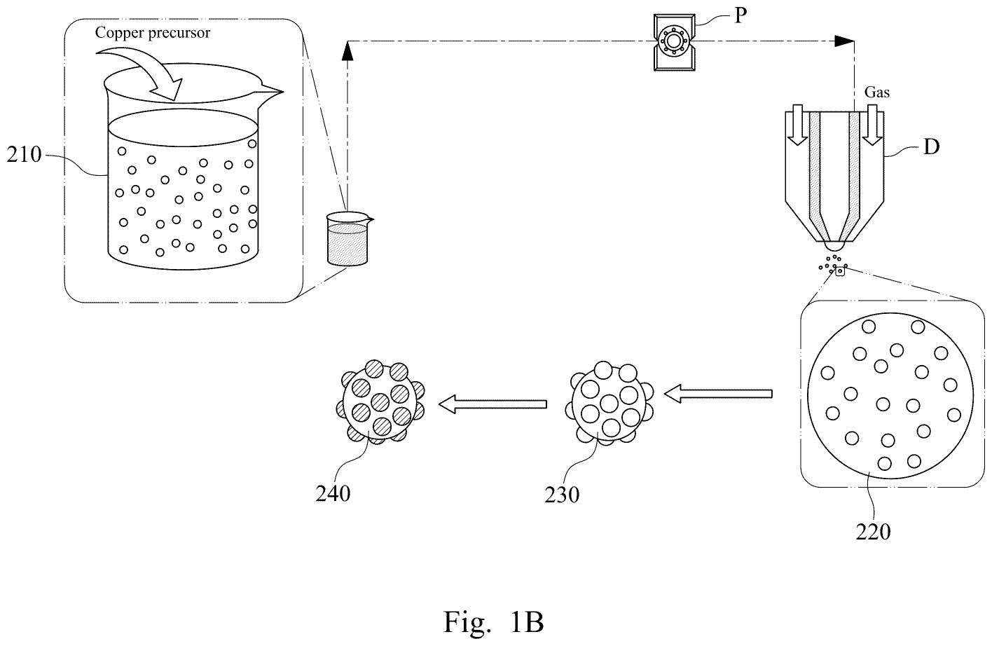

Reference is made to FIG. 1A and FIG. 1B. FIG. 1A is a flow chart of a manufacturing method of a solid copper-carbon catalyst 100 according to one embodiment of the present disclosure, and FIG. 1B is a process diagram of the manufacturing method of the solid copper-carbon catalyst 100 according to FIG. 1A. The manufacturing method of the solid copper-carbon catalyst 100 includes step 110, step 120, step 130 and step 140.

In detail, in step 110, a copper precursor solution 210 is provided, wherein the copper precursor solution 210 includes a copper precursor, a carbon carrier and a first solvent. The copper precursor can be copper (II) nitrate trihydrate (Cu(NO₃)₂3H₂O), the carbon carrier can be an activated carbon powder and the first solvent can be water or ethanol. A weight percent range of the copper precursor in the copper precursor solution 210 can be from 0.38 wt % to 0.76 wt %, and a weight percent range of the carbon carrier in the copper precursor solution 210 can be from 0.8 wt % to 0.9 wt %.

In step 120, a spraying step is performed wherein the copper precursor solution 210 is dispersed to form a plurality of copper precursor drops 220. For example, the spraying step and a following drying step can be performed by a spray dryer D, wherein the spray dryer D can include a first channel and a second channel. The first channel and the second channel are connected to a nozzle, wherein the copper precursor solution 210 can be delivered to the first channel of the spray dryer D via a peristaltic pump P, and a high-pressure gas (e.g., a high-pressure air) is outputted from the second channel. The high-pressure gas can help to disperse the copper precursor solution 210, which makes the copper precursor solution 210 to be sprayed to form the copper precursor drops 220 via the nozzle.

Furthermore, a diameter of each copper precursor drop 220 can be from 5 μm to 20 μm, and preferably it can be 10 μm. For example, an open diameter of the aforementioned nozzle can be approximately 0.7 mm, which enables the diameter of copper precursor drops 220 to meet the aforementioned diameter range, thereby controlling a catalyst particle size subsequently prepared.

In step 130, a drying step is performed, wherein the copper precursor drops 220 are dried to form a plurality of copper precursor powders 230. For example, the spray dryer D can further include a drying chamber (not shown) connecting to the aforementioned nozzle. A dry air is filtered and then introduced into the drying chamber, and a flow rate of the dry air can be 30 m³ per hour. When the copper precursor drops 220 enter the drying chamber and are contacted to the dry air, the first solvent in the copper precursor drops 220 will volatilize due to contact with the dry air, and the copper precursors will precipitate and adhere to the surface of the carbon carriers to form the copper precursor powders 230, in which the copper precursors are loaded on the carbon carriers. After drying, the copper precursor powders 230 move with the dry air and the copper precursor powders 230 can be separated from the dry air by a cyclone separator to collect the copper precursor powders 230. However, the methods for separating the copper precursor powders 230 and drying air are not limited thereto in the present disclosure.

In the drying step, the copper precursor drops 220 are dried at a drying temperature, and the drying temperature can be from 150° C. to 200° C., preferably it can be 170° C. That is, the aforementioned dry air can be heated at the drying temperature in advance in order to dry the copper precursor drops 220 and to ensure that the first solvent in the copper precursor drops 220 can be removed successfully by adjusting the drying temperature.

In step 140, a calcining step is performed, wherein the copper precursor powders 230 are calcined to form a plurality of solid copper-carbon catalysts 240. For example, the copper precursor powders 230 can be placed into a quartz tube and be calcined in a nitrogen environment by a tube furnace (not shown) to make the copper precursor powders 230 be cracked thermally to form cupric oxide (CuO). The carbon carrier can be used as a reductant to reduce the cupric oxide into cuprous oxide (Cu₂O) and metal copper under high temperature to form the solid copper-carbon catalysts 240.

In the calcining step, the copper precursor powders 230 are calcined at a calcining temperature for a calcining time period. The calcining temperature can be from 300° C. to 500° C., preferably can be from 350° C. to 450° C., and the calcining time period can be from 3 hours to 5 hours, preferably it can be 4 hours, thereby ensuring the cuprous oxide and the metal copper are formed sufficiently.

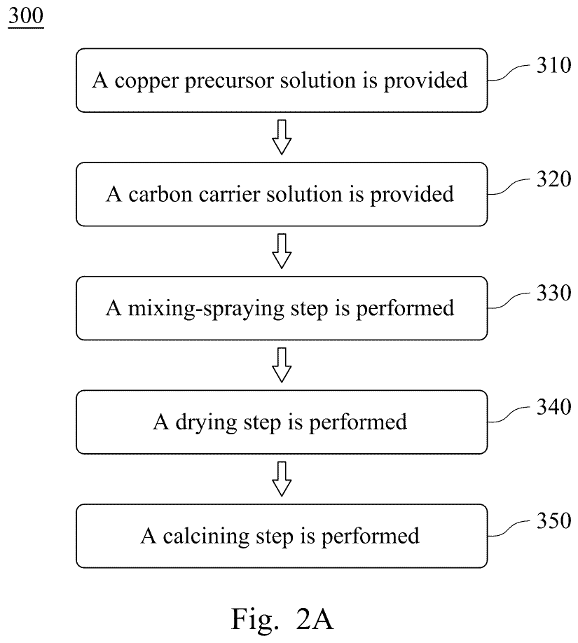

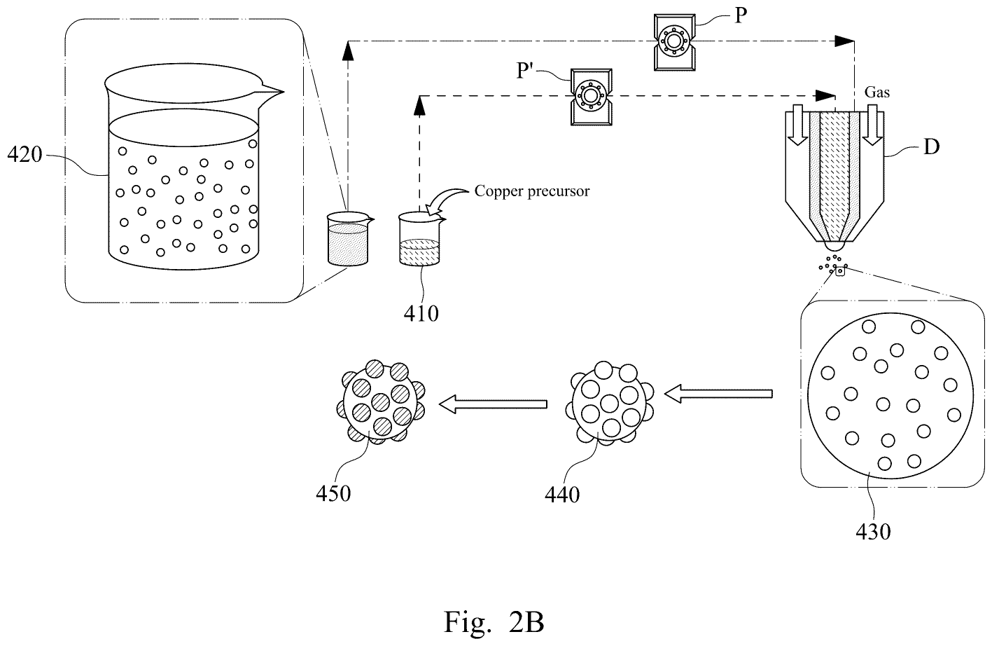

Reference is made to FIG. 2A and FIG. 2B. FIG. 2A is a flow chart of a manufacturing method of a solid copper-carbon catalyst 300 according to another embodiment of the present disclosure, and FIG. 2B is a process diagram of the manufacturing method of the solid copper-carbon catalyst 300 according to FIG. 2A. The manufacturing method of the solid copper-carbon catalyst 300 includes step 310, step 320, step 330, step 340 and step 350.

In detail, in step 310, a copper precursor solution 410 is provided, wherein the copper precursor solution 410 includes a copper precursor and a second solvent. The copper precursor can be copper (II) nitrate trihydrate and the second solvent can be water. Furthermore, a weight percent range of the copper precursor in the copper precursor solution 410 can be from 0.38 wt % to 0.76 wt %.

In step 320, a carbon carrier solution 420 is provided, wherein the carbon carrier solution 420 includes a carbon carrier and a third solvent. The carbon carrier can be an activated carbon powder and the third solvent can be ethanol. Furthermore, a weight percent range of the carbon carrier in the carbon carrier solution 420 can be from 0.8 wt % to 0.9 wt %.

In step 330, a mixing-spraying step is performed, wherein the copper precursor solution 410 and the carbon carrier solution 420 are contacted and mixed to form a mixed solution, and the mixed solution is dispersed to form a plurality of mixture drops 430. For example, the mixing-spraying step and a following drying step can be performed by the spray dryer D, wherein the spray dryer D can include a first channel, a second channel and a third channel. The first channel, the second channel and the third channel are connected to a nozzle, wherein the copper precursor solution 410 and the carbon carrier solution 420 can be delivered separately to the first channel and the second channel of the spray dryer D via peristaltic pumps P and P′, respectively, and to be contacted and mixed at the nozzle to form the mixed solution. A high-pressure gas (e.g., high-pressure air) is outputted from the third channel. The high-pressure gas can help to disperse the mixed solution, which makes the mixed solution to be sprayed to form the mixture drops 430 that are sprayed via the nozzle.

Furthermore, a diameter of each mixture drop 430 can be from 5 μm to 20 μm, preferably it can be 10 μm. For example, an open diameter of the aforementioned nozzle can be approximately 0.5 mm, which enables the diameter of mixture drops 430 to meet the aforementioned diameter range, thereby controlling a catalyst particle size subsequently prepared.

In step 340, a drying step is performed, wherein the mixture drops 430 are dried to form a plurality of to-be calcined powders 440. A method of drying the mixture drops 430 and collecting the to-be calcined powders 440 can be the same as, or similar to the aforementioned embodiments, and the details will not be repeated here. In the drying step, the mixture drops 430 are dried at a drying temperature, and the drying temperature can be from 150° C. to 200° C., preferably it can be 170° C., to ensure that the second solvent and the third solvent in the mixture drops 430 can be removed successfully.

In step 350, a calcining step is performed, wherein the to-be-calcined powders 440 are calcined to form a plurality of solid copper-carbon catalysts 450. A method of calcining the to-be-calcined powders 440 can be the same as, or similar to the aforementioned embodiment, and the details will not be repeated here. In the calcining step, the to-be-calcined powders 440 are calcined at a calcining temperature for a calcining time period. The calcining temperature can be from 300° C. to 500° C., preferably it can be from 350° C. to 450° C. and the calcining time period can be from 3 hours to 5 hours, preferably it can be 4 hours, thereby ensuring the cuprous oxide and the metal copper are formed sufficiently.

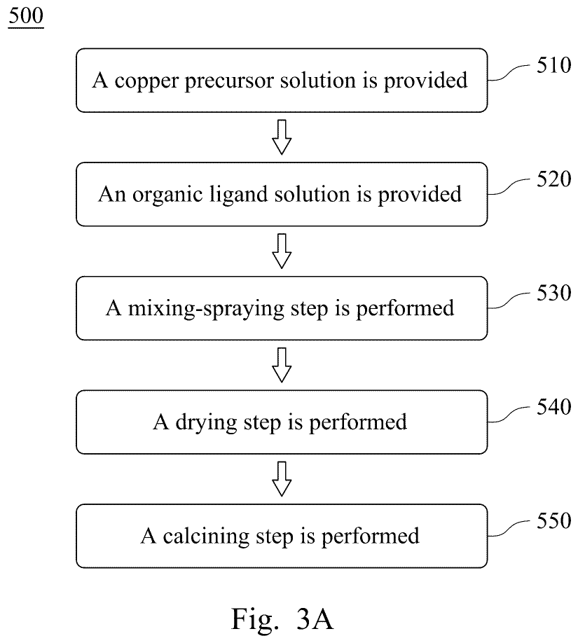

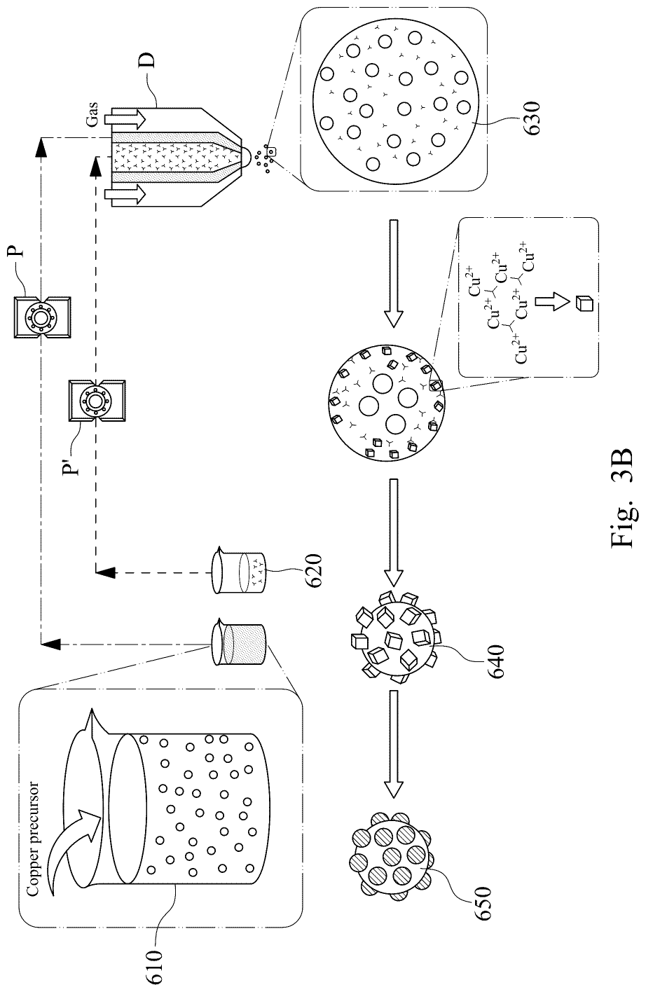

Reference is made to FIG. 3A and FIG. 3B. FIG. 3A is a flow chart of a manufacturing method of a solid copper-carbon catalyst 500 according to a further embodiment of the present disclosure, and FIG. 3B is a process diagram of the manufacturing method of the solid copper-carbon catalyst 500 according to FIG. 3A. The manufacturing method of the solid copper-carbon catalyst 500 includes step 510, step 520, step 530, step 540 and step 550.

In detail, in step 510, a copper precursor solution 610 is provided, wherein the copper precursor solution 610 includes a copper precursor, a carbon carrier and a fourth solvent. The copper precursor can be copper (II) nitrate trihydrate, the carbon carrier can be an activated carbon powder, and the fourth solvent can be a mixture of water and ethanol in a volume ratio of 1:1. A weight percent range of the copper precursor in the copper precursor solution 610 can be from 0.38 wt % to 0.76 wt % and a weight percent range of the carbon carrier in the copper precursor solution 610 can be from 0.8 wt % to 0.9 wt %.

In step 520, an organic ligand solution 620 is provided, and the organic ligand solution 620 includes an organic ligand and a fifth solvent. The organic ligand can be benzene-1, 3, 5-tricarboxylic acid, the fifth solvent can be the mixture of water and ethanol in a volume ratio of 1:1, and a weight percent range of the organic ligand in the organic ligand solution 620 can be from 0.22 wt % to 0.44 wt %.

In step 530, a mixing-spraying step is performed, wherein the copper precursor solution 610 and the organic ligand solution 620 are contacted and mixed to form a mixed solution, and the mixed solution is dispersed to form a plurality of mixture drops 630. For example, the mixing-spraying step and a subsequent drying step can be performed by the spray dryer D, wherein the spray dryer D can include a first channel, a second channel and a third channel. The first channel, the second channel and the third channel are connected to a nozzle, wherein the copper precursor solution 610 and the organic ligand solution 620 can be delivered separately to the first channel and the second channel of the spray dryer D via peristaltic pumps P and P′, respectively, and to be contacted and mixed at the nozzle to form the mixed solution. A high-pressure gas (e.g., high-pressure air) is outputted from the third channel. The high-pressure gas can help to disperse the mixed solution, which makes the mixed solution to be sprayed to form the mixture drops 630 that are sprayed by via the nozzle.

Furthermore, a diameter of each mixture drop 630 can be from 5 μm to 20 μm, preferably it can be 10 μm. For example, an open diameter of the aforementioned nozzle can be approximately 0.5 mm, which enables the diameter of the mixture drops 630 to meet the aforementioned diameter range, thereby controlling a catalyst particle size subsequently prepared.

In step 540, a drying step is performed, wherein the mixture drops 630 are dried to form a plurality of to-be calcined powders 640. A method of drying the mixture drops 630 and collecting the to-be calcined powders 640 can be the same as, or similar to the aforementioned embodiment, and the details will not be repeated here. In the drying step, the mixture drops 630 are dried at a drying temperature, and the drying temperature can be from 150° C. to 200° C., preferably can be 170° C., which is to ensure that the fourth solvent and the fifth solvent in the mixture drops 630 can be removed successfully.

In step 550, a calcining step is performed, wherein the to-be calcined powders 640 are calcined to form a plurality of solid copper-carbon catalysts 650. A method of calcining the to-be-calcined powders 640 can be the same as, or similar to the aforementioned embodiment, and the details will not be repeated here. In the calcining step, the to-be-calcined powders 640 are calcined at a calcining temperature for a calcining time period. The calcining temperature can be from 300° C. to 500° C., preferably can be from 350° C. to 450° C. and the calcining time period can be from 3 hours to 5 hours, preferably it can be 4 hours, thereby ensuring the cuprous oxide and the metal copper are formed sufficiently.

Reference will now be made in detail to the present embodiments of the present disclosure, examples of which are illustrated in the accompanying drawings.

### 1st Example

In the 1st example, a solid copper-carbon catalyst is manufactured from the aforementioned manufacturing method of the solid copper-carbon catalyst 100. In detail, a copper precursor solution of the 1st example includes a copper precursor, a carbon carrier and a first solvent. The copper precursor is copper (II) nitrate trihydrate, the carbon carrier is an activated carbon powder and the first solvent is water. The copper precursor solution of the 1st example undergoes a spraying step, a drying step and a calcining step so as to form the solid copper-carbon catalysts. A drying temperature in the drying step is 170° C., a calcining temperature in the calcining step is 450° C., and a copper loading ratio in the solid copper-carbon catalyst of the 1st example (hereinafter referred to as 1st example) is 10 wt %.

### 2nd Example

In the 2nd example, a solid copper-carbon catalyst of the 2nd example (hereinafter referred to as 2nd example) is manufactured using a manufacturing method of a solid copper-carbon catalyst similar to that used in the 1st example. The difference being that the calcining temperature in the calcining step in the 2nd example is 350° C.

### 3rd Example

In the 3rd example, a solid copper-carbon catalyst of the 3rd example (hereinafter referred to as 3rd example) is manufactured using a manufacturing method of a solid copper-carbon catalyst similar to that used in the 1st example. The difference being that the copper loading ratio in the 3rd example is 20 wt %.

### 4th Example

In the 4th example, a solid copper-carbon catalyst of the 4th example (hereinafter referred to as 4th example) is manufactured using a manufacturing method of a solid copper-carbon catalyst similar to that used in the 1st example. The difference being that the first solvent in the 4th example is ethanol.

### 5th Example

In the 5th example, a solid copper-carbon catalyst of the 5th example (hereinafter referred to as 5th example) is manufactured using a manufacturing method of a solid copper-carbon catalyst similar to that used in the 1st example. The differences are that the first solvent is ethanol, and the calcining temperature in the 5th example is 350° C.

### 6th Example

In the 6th example, a solid copper-carbon catalyst is manufactured from the aforementioned manufacturing method of a solid copper-carbon catalyst 300. In detail, a copper precursor solution of the 6th example includes a copper precursor and a second solvent. The copper precursor is copper (II) nitrate trihydrate and the second solvent is water. Moreover, a carbon carrier solution of the 6th example includes a carbon carrier and a third solvent. The carbon carrier is an activated carbon powder, and the third solvent is ethanol. The copper precursor solution and the carbon carrier solution of the 6th example undergo a mixing-spraying step, a drying step and a calcining step so as to form the solid copper-carbon catalyst of the 6th example (hereinafter referred to as 6th example), wherein, a drying temperature is 170° C. in the drying step, a calcining temperature is 450° C. in the calcining step, and a copper loading ratio in the 6th example is 10 wt %.

### 7th Example

In the 7th example, a solid copper-carbon catalyst of the 7th example (hereinafter referred to as 7th example) is manufactured using a manufacturing method of a solid copper-carbon catalyst similar to that used in the 6th example. The difference being that the calcining temperature in the 7th example is 350° C.

### 8th Example

In the 8th example, a solid copper-carbon catalyst is manufactured from the aforementioned manufacturing method of a solid copper-carbon catalyst 500. In detail, a copper precursor solution of the 8th example includes a copper precursor, a carbon carrier and a fourth solvent. The copper precursor is copper (II) nitrate trihydrate, the carbon carrier is an activated carbon powder, and the fourth solvent is a mixture of water and ethanol in a volume ratio of 1:1. In the 8th example, an organic ligand solution includes an organic ligand and a fifth solvent. Moreover, the organic ligand is benzene-1, 3, 5-tricarboxylic acid, and the fifth solvent is a mixture of water and ethanol in a volume ratio of 1:1. The copper precursor solution and the organic ligand solution of the 8th example undergo a mixing-spraying step, a drying step and a calcining step so as to form the solid copper-carbon catalyst of the 8th example (hereinafter referred to as 8th example), wherein a drying temperature is 170° C. in the drying step, a calcining temperature is 450° C. in the calcining step, and a copper loading ratio in the 8th example is 10 wt %.

### 9th Example

In the 9th example, a solid copper-carbon catalyst of the 9th example (hereinafter referred to as 9th example) is manufactured using a manufacturing method of a solid copper-carbon catalyst similar to that used in the 8th example. The difference being that the copper loading ratio in the solid copper-carbon catalyst in the 9th example is 20 wt %.

### 1 st Comparative Example

A solid copper-carbon catalyst of the 1st comparative example (hereinafter referred to as 1st comparative example) is manufactured by a precipitation method. In detail, in the 1st comparative example, 100 ml of an aqueous solution containing copper nitrate (a weight percent of copper nitrate in the aqueous solution is 0.76 wt %) is poured into a burette and slowly dripped into 300 mL of an excess-ammonia solution containing activated carbon powders (a weight percent of the activated carbon powders in the excess-ammonia solution is 0.6 wt %) at room temperature by back titration, while turning on a stirrer at a speed of 400 rpm (revolutions per minute) for stirring of the titrating solution. A pH value of the excess-ammonia solution containing activated carbon powders is greater than 10.

When the pH value of the aforementioned titrating solution reaches 8, the titration is completed, and the titration solution that has been titrated is called “mother liquid” hereinafter. Afterwards, the mother liquid is aged in an oil bath at 60° C. for 12 hours, and then the aged mother liquid is vacuum-filtered and rinsed with deionized water several times until the filtration solution is neutral. A filter cake obtained by the filtration is dried in an oven at 100° C. overnight, and then a completely dried filter cake is calcined in a calcining furnace at 450° C. for 4 hours under a nitrogen environment. After that, a solid copper-carbon catalyst of the 1st comparative example can be obtained, and a copper loading ratio in the 1st comparative example is 10 wt %.

Especially, the copper loading ratio in the aforementioned solid copper-carbon catalyst is a weight percent of metal copper in the solid copper-carbon catalyst, and the calculation is below:

$${mc}_{u} / ( {mc}_{u} + {m}_{AC} ) \times 100 wt \% ;$$

wherein m_{Cu} represents weight of metal copper in the solid copper-carbon catalyst, and mac represents weight of activated carbon powder in the solid copper-carbon catalyst.

### <Crystal Structure Analysis of a Solid Copper-Carbon Catalyst>

In this experiment, an X-ray diffractometer is used to analyze the 1st example, the 2nd example, the 3rd example, the 4th example, the 5th example, the 6th example, the 7th example, the 8th example and the 9th example, and the results are compared with the diffractometer results of the activated carbon powder to determine the crystal structures of the 1st example to the 9th example. A scanning speed of the X-ray diffractometer is 2° per minute, a scanning range is between 5° to 80°, and a scanning step is 0.05°.

Furthermore, crystal sizes of metal copper and cuprous oxide can be calculated according to the X-ray diffraction results and Debye-Scherrer equation. Debye-Scherrer equation is below:

$${d}_{C} = \frac{K λ}{fwhm cos θ} ;$$

wherein d_{c} represents crystal size, K represents parameter of broadening peak value (K is 1 here), λ represents wave length of X-ray (λ is 1.5406 Å here), fwhm represents half-maximum width of intensity, and θ represents diffraction angle (2θ of Copper (111) is 43.3°, and 2θ of cuprous oxide (111) is 36.4°).

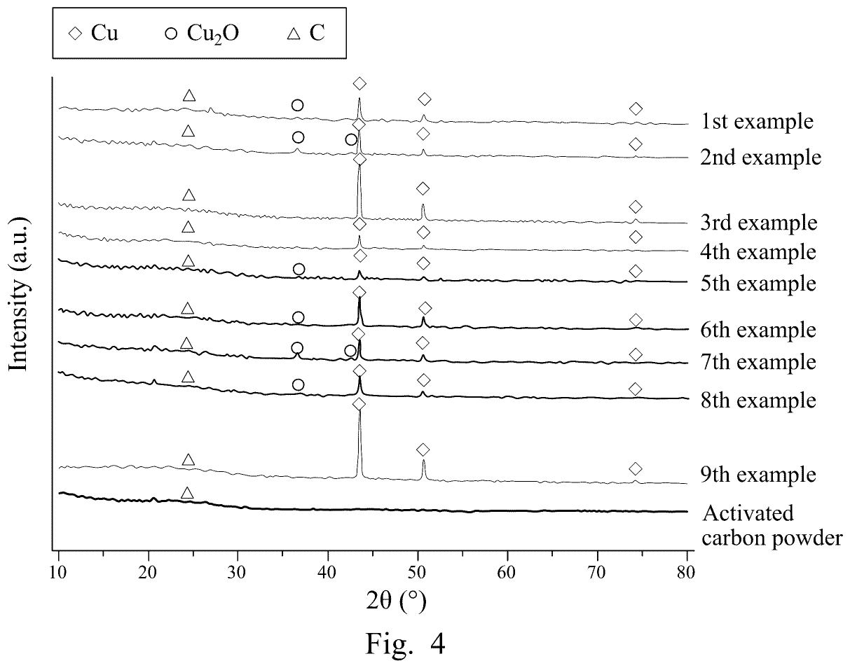

Reference is made to FIG. 4, which is an X-ray diffraction image of the 1st example to the 9th example and the activated carbon powder. As shown in FIG. 4, the 1st example to the 9th example all have diffraction peaks at 2θ of 24.3°, 43.3°, 50.4°, and 74.1°, wherein the broad diffraction peak at 24.3° is the diffraction peak of the activated carbon powder, and the diffraction peaks at 43.3°, 50.4°, and 74.1° are the diffraction peaks of the metal copper. These results indicate that the activated carbon powder and the metal copper are presented in the 1st example to the 9th example.

Moreover, according to FIG. 4, only the 1st example, the 2nd example and the 5th example to the 8th example have the diffraction peaks at 2θ of 36.4° and 42.5°, which are the diffraction peaks of cuprous oxide. These results indicate that the cuprous oxides are presented in the 1st example, the 2nd example and also in the 5th example to the 8th example.

Reference is made to Table 1 below, which lists crystal sizes of metal copper and cuprous oxide in the 1st example to the 9th example. According to FIG. 4 and Table 1, when the copper loading ratio in the solid copper-carbon catalyst is higher, the crystal size of the copper precursor is relatively larger. Therefore, the copper precursor with a larger active metal surface is more easily reduced to metal copper by adjacent activated carbon powders, which is why the diffraction peaks of the cuprous oxide unlikely occur in the examples with the copper loading ratio of 20 wt %.

TABLE 1

| | Crystal size of metal | Crystal size of cuprous |
|---|---|---|
| | copper (nm) | oxide (nm) |
| 1st example | 34.8 | 11.8 |
| 2nd example | 34.4 | 9.4 |
| 3rd example | 37.8 | — |
| 4th example | 36.3 | 20.4 |
| 5th example | 35.9 | 12.9 |
| 6th example | 35.5 | 17.8 |
| 7th example | 35.1 | 14.8 |
| 8th example | 35.6 | 36.5 |
| 9th example | 38.9 | — |

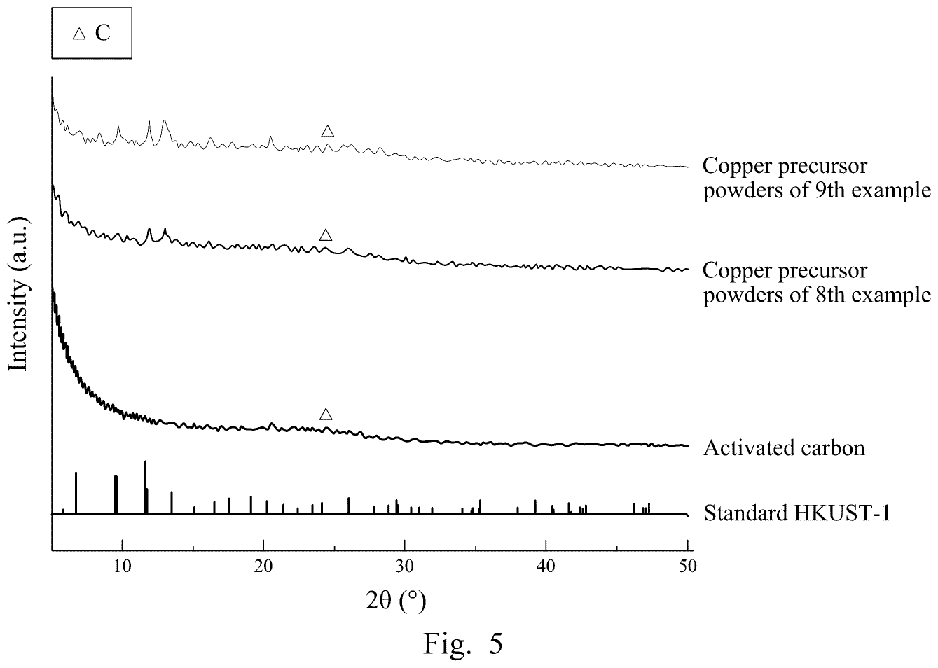

Reference is made to FIG. 5, which is an X-ray diffraction image of copper precursor powders of the 8th example and copper precursor powders of the 9th example, the activated carbon powder, and a standard HKUST-1. According to FIG. 5, the copper precursor powders of the 8th example and copper precursor powders of the 9th example both have diffraction peaks at 2θ of 6.7°, 9.5°, 11.7°, and 13.5° that are the diffraction peaks of the standard HKUST-1 (Copper benzene-1,3,5-tricarboxylate with metal-organic framework material; CAS: 222404-02-6). These results indicate that the metal-organic framework of HKUST-1 is presented in the 8th example and the 9th example before the calcining step. Furthermore, as the copper loading ratio of the solid copper-carbon catalyst increases, the intensity of the aforementioned diffraction peak is more obvious. These results indicate that when the copper loading ratio is increased, the crystallinity of HKUST-1 can be improved.

### <Specific Surface Area of Solid Copper-Carbon Catalyst, and Dispersion and Specific Surface Area of Metal Copper Thereof>

In this experiment, the specific surface area of the 1st example to the 9th example and the dispersion and the specific surface area of metal copper thereof are measured.

The specific surface area of the solid copper-carbon catalyst is measured by the N₂ adsorption/desorption isotherms and the Brunauer-Emmett-Teller (BET) method. During the measurement, the relative pressure ranges from 0.01 to 0.99, the temperature is 77 K and the absolute pressure ranges from 7.8 mmHg to 776 mmHg. Before the measurement, each example is degassed under a nitrogen environment at 120° C. for 8 hours.

The dispersion and the specific surface area of metal copper are measured by dissociative N₂O adsorption. 1. Each example is exposed to dinitrogen oxide at 60° C. for 1 hour, which oxidizes the metal copper to form the cuprous oxide, and this is then followed by reduction of the cuprous oxide to form the metal copper by H₂ temperature-programed reduction (H₂-TPR). Furthermore, the hydrogen consumption amount is measured by a thermal conductivity detector (TCD). The hydrogen consumption amount is the dissociative adsorption amount of dinitrogen oxide, and based on this, the dispersion and the specific surface area of metal copper can be further obtained.

Reference is made to Table 2 below, which lists the specific surface area of the solid copper-carbon catalyst, the dispersion and the specific surface area of metal copper in the 1st example to the 9th example, a solid copper-carbon catalyst of the 2nd comparative example (hereinafter referred to as 2nd comparative example) and a solid copper-carbon catalyst of the 3rd comparative example (hereinafter referred to as 3rd comparative example). The 2nd comparative example is manufactured by the incipient wetness impregnation method, and the 3rd comparative example is manufactured by the triconstituent co-assembly method. According to Table 2, the solid copper-carbon catalysts manufactured by the manufacturing method of the solid copper-carbon catalyst of the present disclosure can simultaneously have relatively large specific surface area of solid copper-carbon catalyst and relatively large specific surface area of metal copper, as well as dispersion of metal copper, which are conductive to the catalytic reaction.

TABLE 2

| | Specific surface | | |
|---|---|---|---|
| | area of the solid | Dispersion of | Specific surface |
| | copper-carbon | the metal | area of the metal |
| | catalyst (m²/g) | copper | copper (m²/g) |
| 1st example | 1338.5 | 14.9 | 9.6 |
| 2nd example | 1387.1 | 16.3 | 10.5 |
| 3rd example | 1176.5 | 9.4 | 12.1 |
| 4th example | 1429.7 | 11.0 | 7.1 |
| 5th example | 1481.6 | 11.5 | 7.4 |
| 6th example | 1337.7 | 14.6 | 9.4 |
| 7th example | 1376.5 | 15.0 | 9.7 |
| 8th example | 1233.3 | 13.6 | 8.8 |
| 9th example | 901.8 | 6.1 | 7.9 |
| 2nd comparative | 1226.0 | 8.9 | 2.4 |
| example | | | |
| 3rd comparative | 369.0 | 17.1 | 5.8 |
| example | | | |

### <Conversion Rate and Selectivity of Solid Copper-Carbon Catalyst>

In this experiment, the conversion rate and the selectivity of the 1st example to the 9th example are measured. In this experiment, 0.5 g of solid copper-carbon catalyst is mixed with 10 g of methanol (MeOH) and carbon monoxide and the air are poured into a reactor to carry out the reaction for 4 hours to form dimethyl carbonate. The reaction equation is as shown below:

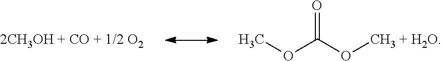

Products formed in the reaction are analyzed by a gas chromatography, and the conversion rate and the selectivity of the solid copper-carbon catalyst can be obtained based on the following equations:

$${X}_{MeOH} = \frac{2 \times {n}_{DMC} + 3 \times {n}_{DMM} + 2 \times {n}_{MF}}{2 \times {n}_{DMC} + 3 \times {n}_{DMM} + 2 \times {n}_{MF} + {n}_{MeOH}} \times 100 \% ;$$

$$and$$

$${S}_{DMC} = \frac{2 \times {n}_{DMC}}{2 \times {n}_{DMC} + 3 \times {n}_{DMM} + 2 \times {n}_{MF}} \times 100 \% ;$$

wherein X_{MeOH} represents conversion rate, S_{DMC} represents selectivity and n_{DMC}, N_{DMM}, n_{MF} and n_{MeOH} represent the mole of dimethyl carbonate, dimethoxymethane (DMM), methyl formate (MF) and methanol, respectively, and DMM and MF are the by-products in the reaction.

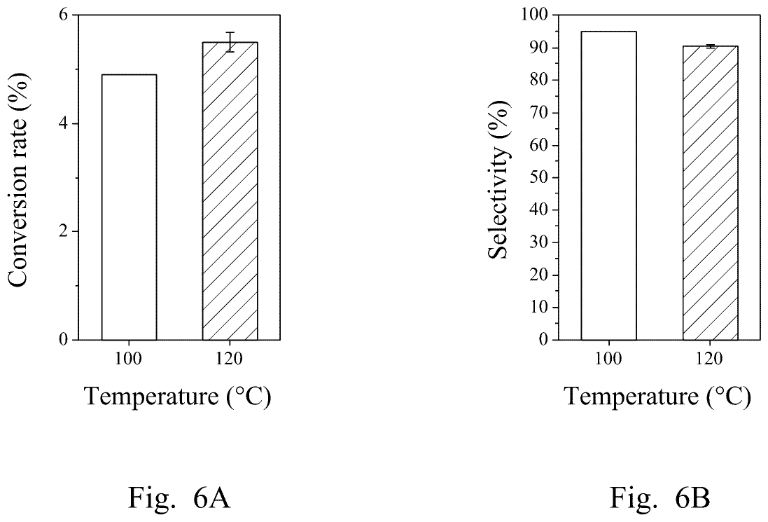

Reference is made to FIG. 6A and FIG. 6B. FIG. 6A is a diagram showing the conversion rate results of the 1st example at different catalytic temperatures, and FIG. 6B is a diagram showing the selectivity results of the 1st example at different catalytic temperatures. According to FIG. 6A and FIG. 6B, when the catalytic temperature is 100° C., the 1st example can achieve high selectivity. As the catalytic temperature increases to 120° C., the conversion rate further increases, and selectivity decreases slightly but maintains at a relatively high level. These results prove that the solid copper-carbon catalysts of the present disclosure can have high selectivity performance, and the catalytic temperature of 120° C. is chosen for use in subsequent experiments.

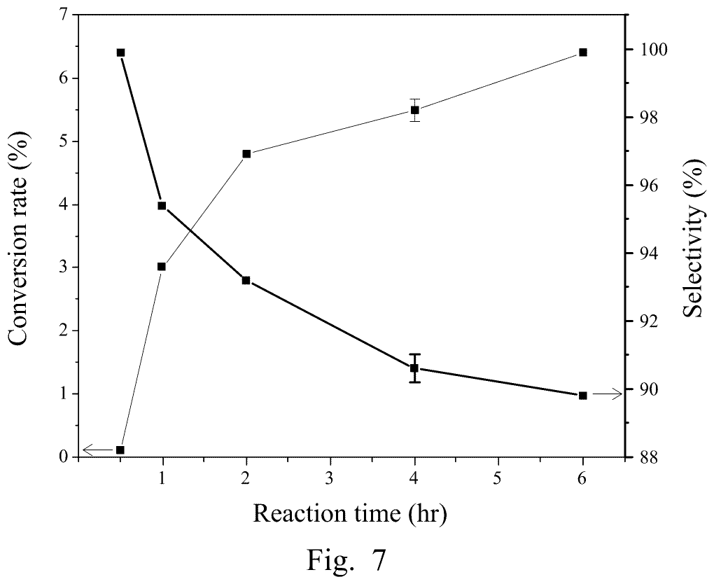

Reference is made to FIG. 7, which is a diagram showing the conversion rate and selectivity changes of the 1st example under different reaction times. According to FIG. 7, as the catalytic reaction progresses selectivity decreases gradually but maintains at higher than 90%, and the conversion rate increases gradually.

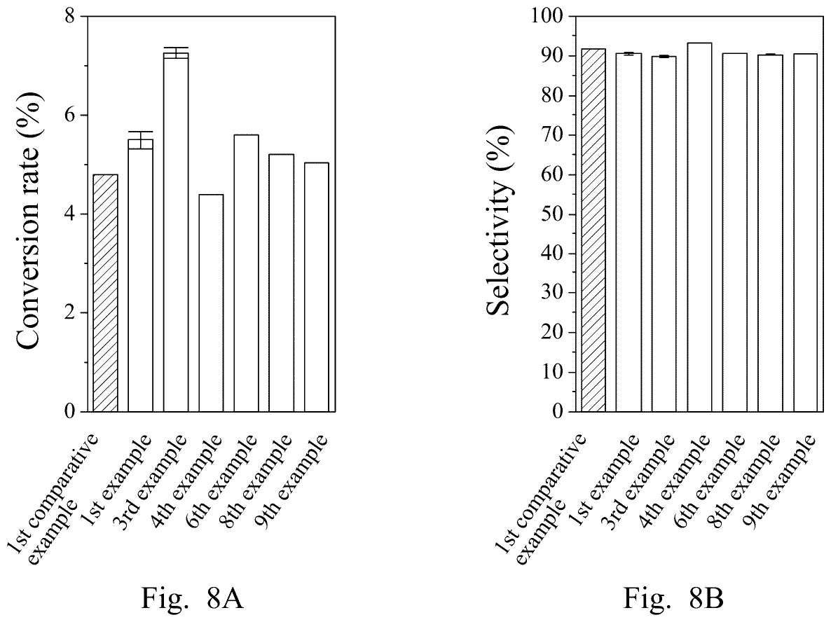

Reference is made to FIG. 8A and FIG. 8B. FIG. 8A is a diagram showing the conversion rate results of the 1st comparative example, the 1st example, the 3rd example, the 4th example, the 6th example, the 8th example and the 9th example at the catalytic temperature of 120° C., and FIG. 8B is a diagram showing the selectivity results of the 1st comparative example, the 1st example, the 3rd example, the 4th example, the 6th example, the 8th example and the 9th example at the catalytic temperature of 120° C. According to FIG. 8A and FIG. 8B, the conversion rates of the 1st example and the 3rd example are clearly higher than the 1st comparative example, and the conversion rates of the 4th example, the 6th example, the 8th example and the 9th example are similar to those of the 1st comparative example. Moreover, the selectivity of each of the aforementioned examples is similar to that of the 1st comparative example and maintains at a high level of selectivity performance. These results indicate that the solid copper-carbon catalyst of the present disclosure has good catalytic effect, which is helpful to reduce raw material costs during a manufacturing process.

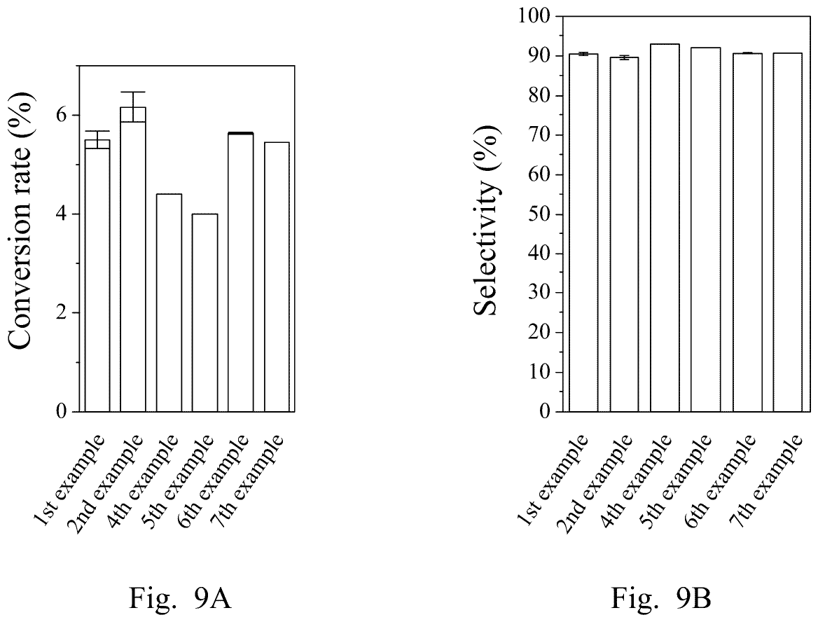

Reference is made to FIG. 9A and FIG. 9B. FIG. 9A is a diagram showing the conversion rate results of the 1st example, the 2nd example, the 4th example, the 5th example, the 6th example and the 7th example at the catalytic temperature of 120° C. FIG. 9B is a diagram showing the selectivity results of the 1st example, the 2nd example, and the 4th example to the 7th example at the catalytic temperature of 120° C. According to FIG. 9A and FIG. 9B, the solid copper-carbon catalysts manufactured at different calcining temperatures all have high selectivity, and the conversion rates of the aforementioned examples are better than, or similar to, that of the 1st comparative example. These results indicate that the solid copper-carbon catalysts manufactured at different calcining temperatures have good catalytic effects in the present disclosure.

In conclusion, the manufacturing method of the solid copper-carbon catalyst of the present disclosure includes a spraying, a drying and a calcining step involving the reactants, that is, the solid copper-carbon catalyst is manufactured by an aerosol method in the present disclosure. Therefore, the manufacturing cost of the solid copper-carbon catalyst manufacturing method as detailed in of the present disclosure is relative low, which is conductive to large-scale synthetic manufacturing and can also be applied to continuous reactors. There is also no need for complicated purification steps to separate out the solid copper-carbon catalyst after the catalytic reaction. Moreover, the copper precursor can be loaded onto the carbon carrier uniformly by the manufacturing method of the present disclosure to form solid copper-carbon catalysts with good catalytic effects. Furthermore, composition, size and other material characteristics of the solid copper-carbon catalyst can be adjusted and tailored to specific requirements, thereby increasing the range of applications of the instantly disclosed solid copper-carbon catalyst.

Although the present disclosure has been described in considerable detail with reference to certain embodiments thereof, other embodiments are possible. Therefore, the spirit and scope of the appended claims should not be limited to the description of the specific embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A manufacturing method of a solid copper-carbon catalyst, comprising:
providing a copper precursor solution comprising a copper precursor, a carbon carrier and a first solvent;
performing a spraying step, wherein the copper precursor solution is dispersed to form a plurality of copper precursor drops;
performing a drying step, wherein the plurality of copper precursor drops are dried to form a plurality of copper precursor powders; and
performing a calcining step, wherein the plurality of copper precursor powders are calcined to form a plurality of solid copper-carbon catalysts.

2. The manufacturing method of the solid copper-carbon catalyst of claim 1, wherein the copper precursor is a copper nitrate trihydrate, the carbon carrier is an activated carbon powder, the first solvent is a water or an ethanol, a weight percent range of the copper precursor in the copper precursor solution is from 0.38 wt % to 0.76 wt %, and a weight percent range of the carbon carrier in the copper precursor solution is from 0.8 wt % to 0.9 wt %.

3. The manufacturing method of the solid copper-carbon catalyst of claim 1, wherein a diameter of each of the plurality of copper precursor drops is from 5 μm to 20 μm.

4. The manufacturing method of the solid copper-carbon catalyst of claim 1, wherein during the drying step, the plurality of copper precursor drops are dried at a drying temperature, and the drying temperature is from 150° C. to 200° C.

5. The manufacturing method of the solid copper-carbon catalyst of claim 1, wherein during the calcining step, the plurality of copper precursor powders are calcined at a calcining temperature for a calcining time period, the calcining temperature is from 300° C. to 500° C., and the calcining time period is from 3 hours to 5 hours.

6. A manufacturing method of a solid copper-carbon catalyst, comprising:
providing a copper precursor solution comprising a copper precursor and a second solvent;
providing a carbon carrier solution comprising a carbon carrier and a third solvent;
performing a mixing-spraying step, wherein the copper precursor solution and the carbon carrier solution are contacted and mixed to form a mixed solution, and the mixed solution is dispersed to form a plurality of mixture drops;
performing a drying step, wherein the plurality of mixture drops are dried to form a plurality of to-be-calcined powders; and
performing a calcining step, the plurality of to-be-calcined powders are calcined to form a plurality of solid copper-carbon catalysts.

7. The manufacturing method of the solid copper-carbon catalyst of claim 6, wherein the copper precursor is a copper nitrate trihydrate, the second solvent is a water, and a weight percent range of the copper precursor in the copper precursor solution is from 0.38 wt % to 0.76 wt %.

8. The manufacturing method of the solid copper-carbon catalyst of claim 6, wherein the carbon carrier is an activated carbon powder, the third solvent is an ethanol, and a weight percent range of the carbon carrier in the carbon carrier solution is from 0.8 wt % to 0.9 wt %.

9. The manufacturing method of the solid copper-carbon catalyst of claim 6, wherein a diameter of each of the plurality of mixture drops is from 5 μm to 20 μm.

10. The manufacturing method of the solid copper-carbon catalyst of claim 6, wherein during the drying step, the plurality of mixture drops are dried at a drying temperature, and the drying temperature is from 150° C. to 200° C.

11. The manufacturing method of the solid copper-carbon catalyst of claim 6, wherein during the calcining step, the plurality of to-be-calcined powders are calcined at a calcining temperature for a calcining time period, the calcining temperature is from 300° C. to 500° C., and the calcining time period is from 3 hours to 5 hours.

12. A manufacturing method of a solid copper-carbon catalyst, comprising:
providing a copper precursor solution comprising a copper precursor, a carbon carrier and a fourth solvent;
providing an organic ligand solution comprising an organic ligand and a fifth solvent;
performing a mixing-spraying step, wherein the copper precursor solution and the organic ligand solution are contacted and mixed to form a mixed solution, and the mixed solution is dispersed to form a plurality of mixture drops;
performing a drying step, wherein the plurality of mixture drops are dried to form a plurality of to-be-calcined powders; and
performing a calcining step, wherein the plurality of to-be-calcined powders are calcined to form a plurality of solid copper-carbon catalysts.

13. The manufacturing method of the solid copper-carbon catalyst of claim 12, wherein the copper precursor is a copper nitrate trihydrate, the carbon carrier is an activated carbon powder, the fourth solvent is prepared with a water and an ethanol in a volume ratio of 1:1, a weight percent range of the copper precursor in the copper precursor solution is from 0.38 wt % to 0.76 wt %, and a weight percent range of the carbon carrier in the copper precursor solution is from 0.8 wt % to 0.9 wt %.

14. The manufacturing method of the solid copper-carbon catalyst of claim 12, wherein the organic ligand is a trimesic acid, the fifth solvent is prepared with a water and an ethanol in a volume ratio of 1:1, and a weight percent range of the organic ligand in the organic ligand solution is from 0.22 wt % to 0.44 wt %.

15. The manufacturing method of the solid copper-carbon catalyst of claim 12, wherein a diameter of each of the plurality of mixture drops is from 5 μm to 20 μm.

16. The manufacturing method of the solid copper-carbon catalyst of claim 12, wherein during the drying step, the plurality of mixture drops are dried at a drying temperature, and the drying temperature is from 150° C. to 200° C.

17. The manufacturing method of the solid copper-carbon catalyst of claim 12, wherein during the calcining step, the plurality of to-be-calcined powders are calcined at a calcining temperature for a calcining time period, the calcining temperature is from 300° C. to 500° C., and the calcining time period is from 3 hours to 5 hours.
